(19) United States
(12) Patent Application Publication
(10) Pub. No.: US 2008/0141110 A1
(43) Pub. Date: Jun. 12, 2008

(54) Hot-linked images and methods and an apparatus for adapting existing images for the same

(75) Inventor: Eyal Gura, Haifa (IL)

Correspondence Address: Martin D. Moynihan;PRTSI, Inc., P.O. Box 16446, Arlington, VA, 22215, US

(73) Assignee: PicScout (Israel) Ltd., Herzlia Pituach (IL)

(21) Appl. No.: 11/987,968

(22) Filed: Dec. 6, 2007

Related U.S. Application Data
(60) Provisional application No. 60/873,259, filed on Dec. 7, 2006.

(51) Int. Cl. G06F 17/00; G06Q 30/00

(52) U.S. Cl. 715/207; 705/14

(57) ABSTRACT

Apparatus for displaying an image or other media in a hypertext mark up language context, the image comprising at least one delineated region, the delineated region comprising a hot link to another location in said hypertext mark up language context. An editing tool is also taught for preparing such images and a method is provided of providing a free at point of use database of images, where DRM fees are paid for by links to advertising.

### RELATED APPLICATION

This application claims the benefit of U.S. Provisional Patent Application No. 60/873,259 filed on Dec. 7, 2006, the contents of which are hereby incorporated by reference.

### FIELD AND BACKGROUND OF THE INVENTION

The present invention relates to hot-linked or hyper-linked media items, including images for use with HTML and the like and methods and apparatus for adapting existing images for the same, and, more particularly, but not exclusively to methods of identifying and hot-linking through features within the image.

The use of hot links within HTML is the basis of the World Wide Web. The user clicks on a link within the text of the web page and is transported to the address included in the link. In this document the terms hot-link and hyper-link are used synonymously.

As well as text it is also well known to provide hot links through other objects than text within the web page. For example links can be provided through images, which is to say an image file can be hot-linked, so that a user can click on an image to be taken to another part of the same web site or to another web site entirely.

In the context of web-sites themselves, many web pages carry advertising material, and often the advertising is fixed in advance. However often the advertising is dynamically selected, and one example of dynamically selected advertising is Adsense™ provided by Google™.

As discussed in Wikipedia, www.wickipedia.org, AdSense is an advertisement serving program run by Google. Website owners can enroll in the program to enable text, image and, more recently, video advertisements on their sites. These advertisements are administered by Google and generate revenue on either a per-click or per-thousand-impressions basis. Google is also currently beta-testing a cost-per-action based service.

Google utilizes its search technology to serve advertisements dynamically based on website content, the user's geographical location, and other factors. Those wanting to advertise with Google's targeted advertising system may sign up through the AdWords signup scheme. AdSense has become a popular method of placing advertising on a website because the advertisements are less intrusive than most banners, and the content of the advertisements eventually placed is often relevant to the website, thus ensuring a better response from users.

The site owner assigns space to Adsense, and the advertising server currently uses JavaScript code to incorporate the advertisements into the participating site. If the space is included on a site which has not yet been crawled by Google's Mediabot, meaning its content has not been studied yet, then the space will temporarily display advertisements for charitable causes known as public service announcements (PSAs). The skilled person will know that the Mediabot is a separate crawler from the Googlebot that maintains Google's search index.

Many sites use AdSense and some webmasters are known to work hard to maximize their own AdSense income. They do this in three ways:

a) They use a wide range of traffic generating techniques including but not limited to online advertising.

b) They build valuable content on their sites; content which attracts relevant AdSense advertisements that are of interest to the site visitors and which pay out the most when they get clicked.

c) They use copy on their websites that encourage clicks on advertisements. Note that Google prohibits people from using phrases like “Click on my AdSense ads” to increase click rates. Phrases accepted are “Sponsored Links” and “Advertisements”.

The source of all AdSense income is the AdWords program which in turn has a complex pricing model based on a Vickrey second price auction, in that it commands an advertiser to submit a sealed bid (not observable by competitors). Additionally, for any given click received, advertisers only pay one bid increment above the second-highest bid.

The way that Adsense works is as follows. Each time a visitor visits a page with an AdSense tag, a piece of JavaScript writes an iframe tag which has an src or source attribute. In this case the src attribute includes the URL of the page. Google's servers use a cache of the page for the URL or the keywords in the URL itself to determine a set of high-value keywords. Further details are explained in U.S. patent application Ser. No. 10/314,427 to Jeffrey A. Dean et al. If keywords have been cached already, advertisements are served for those keywords based on the AdWords bidding system. The end result is that the user visiting the page sees the in-context advertisements.

Another feature that exists is the in-text advertisement, such as currently provided by VibrantMedia and Kontera. A piece of text may be hot-linked to an advertisement that has to do with the nature of the text. Alternatively the cursor may be moved over the text containing the hot link and the advertisement becomes visible.

It is important for advertisers to obtain good effective advertising space, and in particular to provide advertisements in a way that attract attention. Users often filter advertisement material from their minds.

The above methods use techniques such as pay-per-click to allow the advertiser to remunerate the provider. Such systems suffer from click frauds. It is estimated that 20% of clicks on advertisements are generated by machines or even by people, to charge their competitor or their advertiser fraudulently. This phenomena has a huge impact on advertisers and the advertising system companies, and generally undermines confidence.

It is important for the advertiser to catch the eye of the potential customers, as mentioned above, in particular in such a way that the user does not filter it from his attention. Thus advertisements often carry images, and in the context of web advertising it is likewise possible to provide hot links to images or other media types so that media files provided on the website can be hot linked to advertising material. However it is not currently possible to provide dynamic or context linking to advertising based on images as the content of the images is not easily understood by computerized systems. That is to say image recognition at the moment is a difficult problem. Although there are plenty of fairly successful context sensitive systems for image recognition, a general image recognition solution, to understand and index items within images, is not currently available.

There is thus a widely recognized need for, and it would be highly advantageous to have, a hot linking system devoid of the above limitations.

### SUMMARY OF THE INVENTION

According to one aspect of the present invention there is provided apparatus for displaying a media item in a hypertext mark up language context, the media item comprising at least one delineated object, the delineated object comprising a hot link to another location in said hypertext mark up language context, the apparatus being configured with a display functionality for displaying said media item and a partial-item hotlinking function for supporting said hotlink of said delineated object.

According to a second aspect of the present invention there is provided an editing device for editing media items for hot-linking, the device comprising an interactive tagging tool for allowing said user to insert keywords to describe respectively delineated objects. The device may optionally comprise an interactive object delimiter for allowing a user to delimit objects within an media item for hot-linking,

According to a third aspect of the present invention there is provided a method of rendering rights protected media freely available to publishing parties comprising:

labeling said media with keywords;

providing publishing parties with access to said media for use thereof;

allowing said advertising parties to hot link advertisement material to objects identified by said keywords;

collecting usage payments from said advertising parties for use of said media by said publishing parties.

The method may optionally comprise delineating objects within said media;

According to a fourth aspect of the present invention there is provided apparatus for rendering rights protected media available to publishing parties, without at least any initial payment, the apparatus comprising:

an optional object delineator for delineating objects within said media;

a tagging tool for labeling said media with keywords;

a database for storing said delineated and labeled media in a manner accessible to publishing parties, to allow said publishing parties to make use thereof; said database being configured to be accessible by said keywords, allowing said advertising parties to hot link advertisement material to objects identified by said keywords; and

a billing unit configured to collect usage payments from said advertising parties for use of said media by said publishing parties.

According to a fifth aspect of the present invention there is provided a method of providing a database with linkable and keyworded media items, comprising:

providing said media items,
providing an editing tool, the editing tool comprising:
an optional interactive object delimiter for allowing a user to delimit regions within an image for hot-linking or mark them with a visual mark, and
an interactive tagging tool for allowing said user to insert keywords or slogans to describe respectively delineated regions;
   making said media items and editing tool available to remote users to allow said remote users to add links and keywords to said media items using said editing tool for a fee.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram illustrating a clip-art style image being displayed on a computer and which is suitable for treatment according to the present invention.

FIG. 2 is a simplified diagram showing what happens when the cursor approaches an image treated according to the present invention or points on the marked sign on the image.

FIGS. 3A and 3B are simplified diagram illustrating two variations of an editing tool according to a preferred embodiment of the present invention.

FIG. 4 is a simplified flow chart illustrating usage of embodiments of the present invention.

FIG. 5A is a simplified flow chart illustrating an alternative usage of embodiments of the present invention.

FIG. 5B is a simplified flow chart showing the advertiser's interaction with a system according to embodiments of the present invention.

FIGS. 6A and 6B are schematic diagrams showing two embodiments of stacks for adjudication between different advertisers using the same keyword, according to a preferred embodiment of the present invention.

FIG. 7 is a simplified block diagram that illustrates apparatus for setting up a database of media items according to a preferred embodiment of the present invention.

FIG. 8 is a simplified diagram illustrating how the apparatus of FIG. 7 may cooperate with other entities over the Internet or like electronic network.

FIG. 9 is a simplified diagram showing an image with hotlinked advertisement according to a further embodiment of the present invention.

### DESCRIPTION OF THE PREFERRED EMBODIMENTS

The present embodiments comprise a method of delineating parts of an image or other media item, providing key terms for the image and the delineated or visually marking parts and concepts and then, using the tags, providing dynamic linking using the images. The present embodiments provide the images and the method of dynamic linking and also provide an editing system for delineating parts of images and providing tags. The present embodiments additionally provide a database of delineated and tagged images.

By using images or like media the tendency to machine based click fraud is overcome because machines have difficulty identifying the objects inside the image. They can identify a competitor's advertisement when it is textual but it is much more difficult when it is an undefined image.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

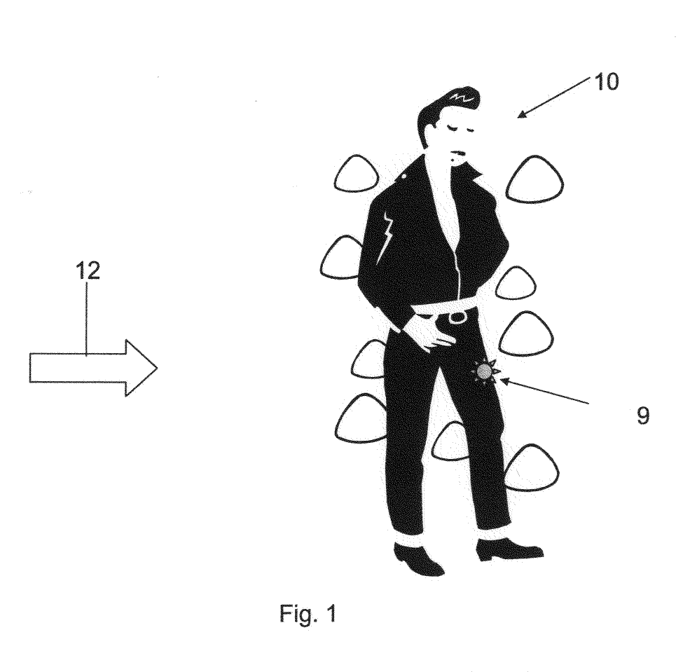

Reference is now made to FIG. 1 which illustrates an image 10 that is typical of the kind of image to be found on a gallery of images located on the Internet. The user of a website may wish to use the image as a graphic on his website and thus may download the image to incorporate in his web pages. The image is made available free of charge or under any other type of license, to the user who incorporates it into his layout. The image appears as a normal image until the cursor 12 approaches it. At the approach of cursor 12 part of the image begins to flash or a slogan appears. In one embodiment the part of the image flashes from the start and the slogan appears when the cursor approaches. As will be explained below, the publisher agrees to certain terms before he joins the system. The system requires that he places certain code on his website. The code allows for a small field on the upper side of the image than can be used to insert a slogan.

It will be appreciated that as well as images, other kinds of media may be considered as long as it is possible to delineate objects, including sketches, clipart, photographs, images, cartoons, animations, and video clips, streaming and other video.

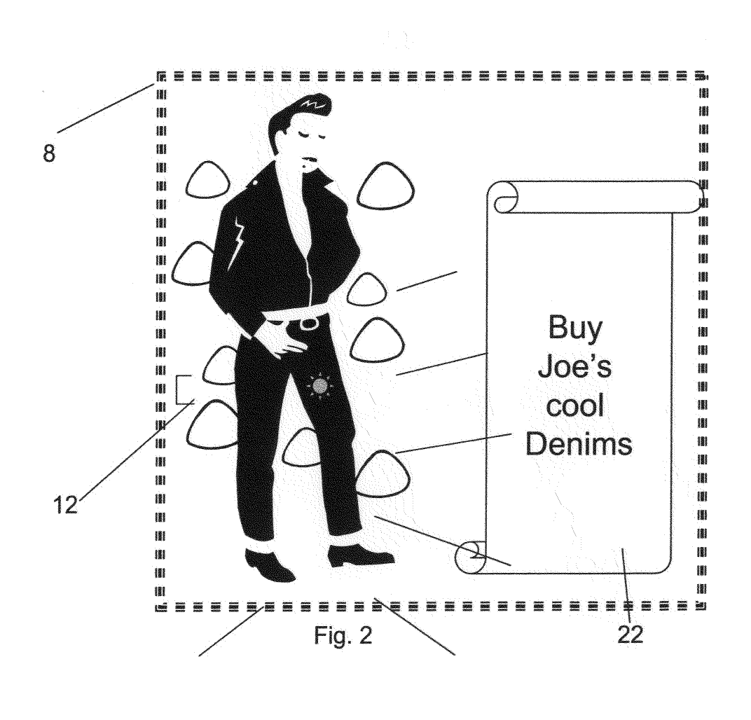

Reference is now made to FIG. 2 which shows a part 14 of the image 10 being animated, most typically flashing, before the cursor 12 approaches. The animated image appears as a Flash bubble having a boundary 8, but is not in fact part of the website of the publisher of the webpage from which the advertisement was accessed.

Alternatively or additionally to flashing, the part 14 could be marked, say with star or tag 9 which could in turn be labeled with a term such as “start”. Along with the flashing etc. a message 16 appears carrying advertising text, say a slogan, or link text. Either or both of the part 14 and the text, that is the slogan, can be clicked to arrive at the website of the advertiser. A single image can have multiple objects, and in one preferred embodiment the different objects flash etc in turn.

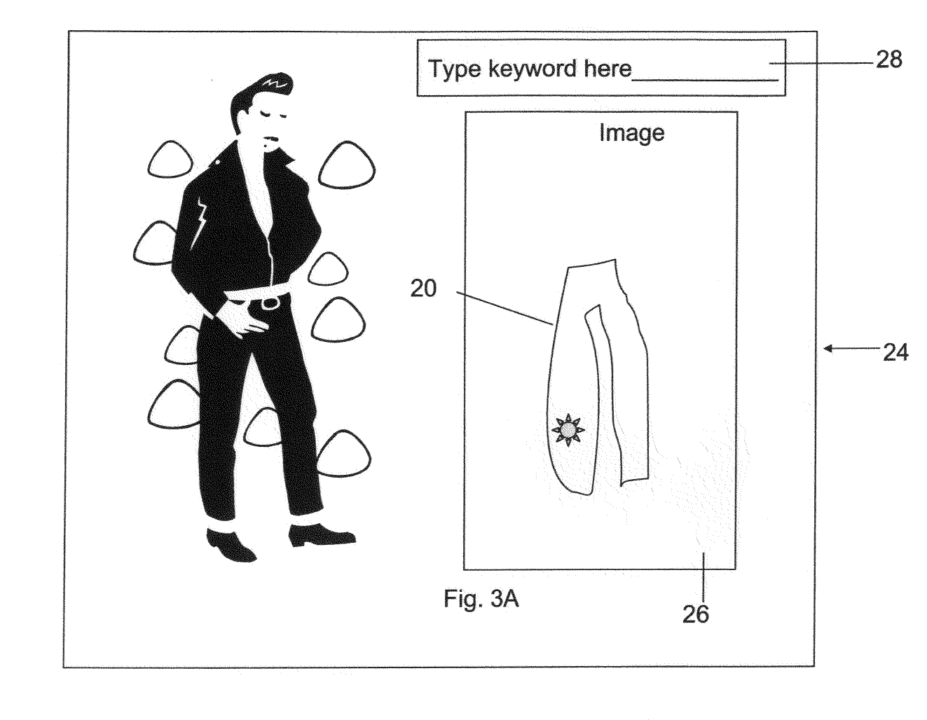

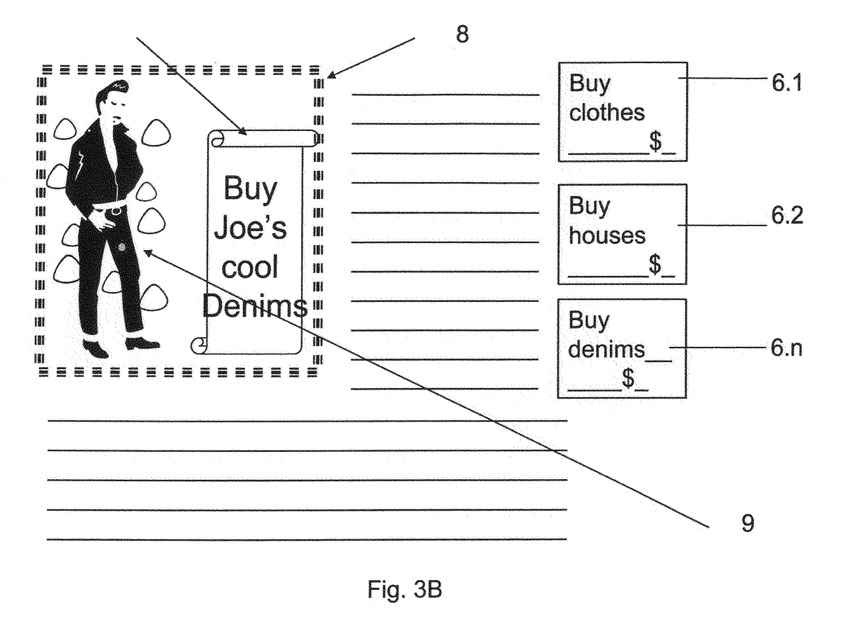

Reference is now made to FIGS. 3A and 3B which are two simplified diagrams illustrating variations of an editing tool 24 for allowing the image of FIG. 1 to be divided into objects and to be related to concepts and slogans. The editing tool comprises a delimiting tool 26 and a keyword entry tool or tagging tool 28.

Prior to the image being made available to the general public, individual objects within the image are identified using the delimiting tool 26, essentially an outlining tool which allows a user to draw an outline around an object or to place a small button or mark on the image. The object is then defined as any part of the image within an outline or in proximity to the small mark. The delimiting tool allows separate objects which may be of interest to advertisers to be defined digitally. As illustrated in FIG. 3 a simple delimitation comprising drawing a line 20 over the image with a mouse, stylus or like user input device, allows for an object to be delimited. In this case line 20 delimits the trousers, and thus the trousers are identified as an object. The same could be repeated for belt, jacket and shoes.

The image and the object are then provided with keywords and phrases using the tagging tool. Keywords may be assigned to the image as a whole and to individual objects therewithin. In the case of image 10, suitable keywords and phrases for the image as a whole would be clothing, mens' clothing, and mens' outerwear. Suitable keywords for the objects could be jacket, trousers, pants, shoes, belt etc. The keywords are preferably entered through a webform or the like on the editing tool. It is noted that keywords are preferably provided both for the image as a whole and for objects therein separately, since, as will be explained below, the website publishers are interested in the image as a whole and the advertisers are interested in the objects within or the slogan and concept of the image.

Another option is to provide a list of keywords with the image and, near each keyword, a small graphical sign such as the yellow star 9. The editor merely needs to drag the mark to the right place in the image so as to associate the place\item with the keyword.

Each keyword may be associated with a visual mark. The mark may include the hot link, and thus the editing tool directly allows the addition of both the keyword and the hotspot to the image part simultaneously.

FIG. 3B shows a series of available slogans 6.1 . . . 6.n. Each has a marker which can be dragged to the object, and the editor selects one of the objects to be used.

In one embodiment the editing tool is made available over the Internet and users are paid to take images and identify objects and provide keywords and creative slogans. Thus a database of active images can be made available.

As a result, a database is set up which contains images that have active objects and keywords. A further party who contributes to the database is the image provider. Images may be obtained from existing stock, or may be uploaded by rights holders. Photographers, animators, artists etc. may provide their own images for the database and may even edit the images themselves using the editing tool.

When the media item is a video or video clip, a preferred method is to take an initial frame and edit the frame as a still image. The link then persists for a number of following frames.

The images produced may be suitable for insertion inside emails, MMS, and also on dynamic touch screens, billboards and the like.

A filtering system may be included which allows the advertiser to define types of files and slogans which are allowed, or which are not allowed to carry his advertisements.

The advertiser can define a smart advertising campaign. He can obtain scenarios of available images that can carry his advertisements, considering his budget, audience and filtering requirements. For any particular scenario the system is able to predict a result in terms of the volume of impressions.

The advertisements originate to the end user from within the bounds of the media item itself and then appear as a small additional window within or without the boundaries of the original image.

In a preferred embodiment, the marked items inside the image and the image slogan may appear at different times to attract the attention of the end user to the item. The system preferably controls the optimize interval of marking/flashing items so as not to overwhelm the end user.

The system is able to dynamically replace advertisements inside the image, so that different items are marked and flash whenever a more relevant advertiser joins the system and advertises a new item.

Alternatively the system simply replaces advertisements inside the image in order to tune the system and optimize it to the specific viewer. That is to say the system builds up profiles on individual users based either on reported preferences or actual response activity. The user profile system however depends on successfully identifying a returning user.

One way in which the system can identify a specific user is using cookies. Whenever a given user watches a website that contains the system images, he sees an advertisement that is relevant to a pre-defined criterion. The user may even wish himself to define advertisements he would like to see and advertisements he would like to filter.

Returning to the editing tool and there may be provided an internal checking system to ensure that images are well keyworded. The system may ask a given editor to edit previously edited images and use a statistical algorithm to maintain keywords that were common to the different editors and delete the keywords that were not.

There are a number of ways in which the database can be used.

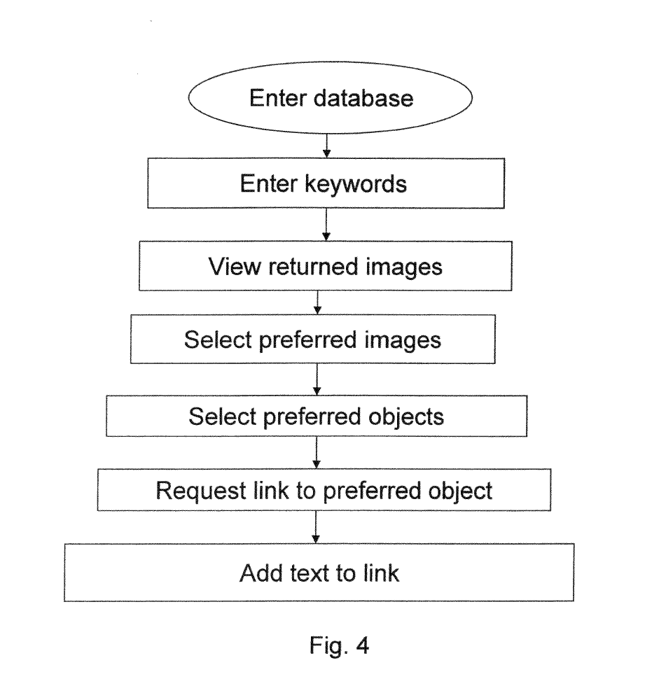

With reference now to FIG. 4, in a first method an advertiser may search the database by entering keywords suitable for the product or products he wishes to sell, retrieve images and select those he deems suitable for the products he is advertising. From the images he selects an object and then obtains a link from that object. Any Internet publisher who downloads the image downloads it with the link and the link pays for the right to use the image.

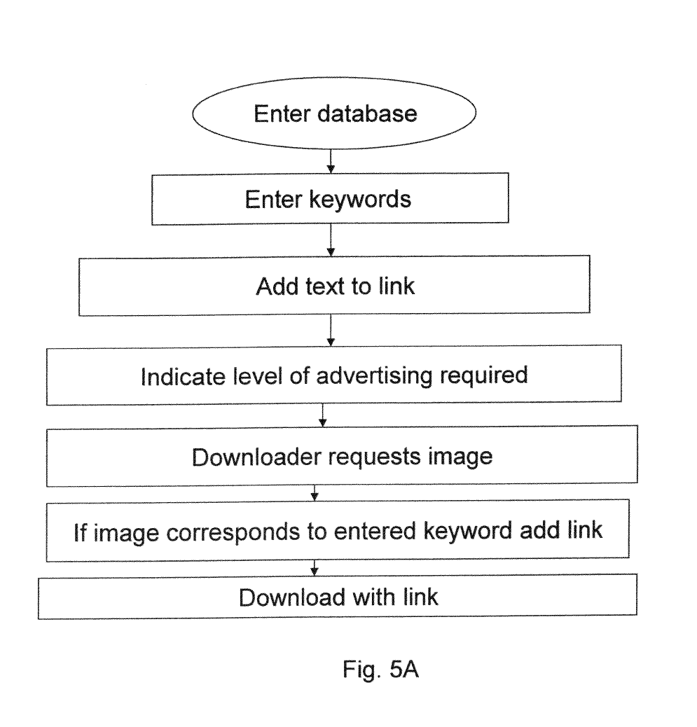

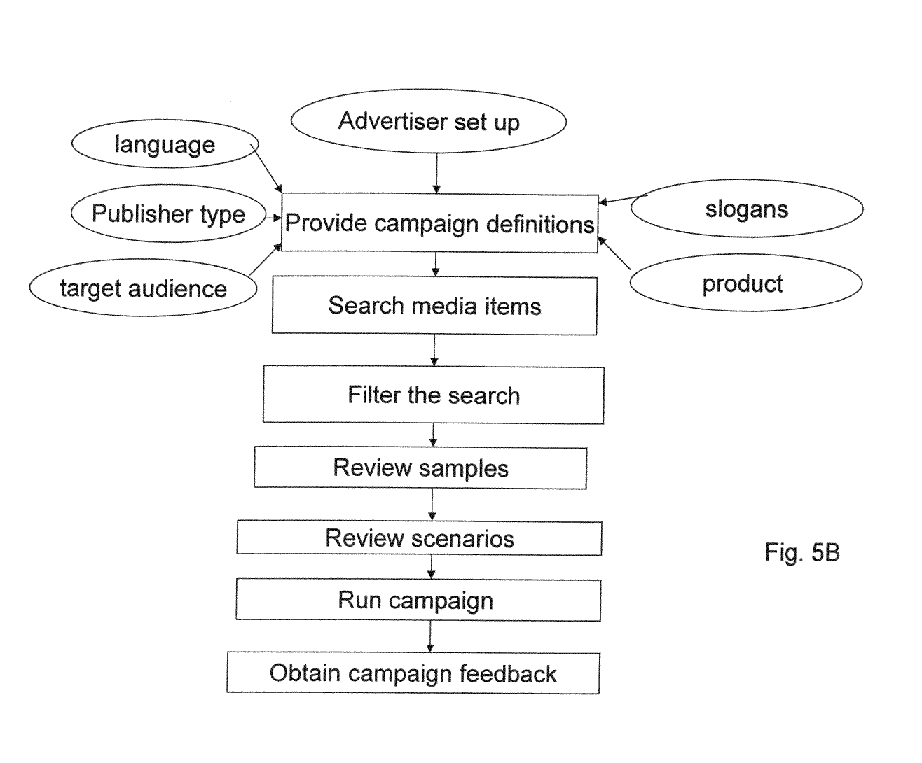

Reference is now made to FIG. 5A which is a simplified flow chart showing an alternative embodiment to that of FIG. 4. In large databases there is no guarantee that anyone will download a selected image. Thus in another preferred embodiment the advertiser merely enters keywords and indicates the advertisement that he requires. Then, whenever an image is downloaded by a publisher, if it has keywords that correspond to the current advertiser then his link may be added. However in this case there is no guarantee that the advertiser approves of the image being used.

Referring now to FIG. 5B an advertiser workflow that deals with the issues raised by FIGS. 4 and 5A, is shown in greater detail. In a first stage the advertiser sets up an account. As part of the account setup he provides definitions of his target audience, desired languages and keywords related to his product. The advertiser may set definitions for types of desired publishers to place his advertisements with, and may obtain, or himself provide, a list of potential slogans for his campaign. The advertiser is then provided a series of images from the database which the system thinks are suitable for his campaign, and the advertiser may then manually mark the images he is prepared to associate his image with.

The advertiser is then able to see samples of images in websites so that he gets a feel for his campaign in action.

The advertiser is able to use the properties of the system to launch a smart campaign: in that he is able to define his needs in terms of audience and budget and obtain options that specify how many images and impressions may carry his campaign. The smart campaign can be refined by running scenarios.

Finally the advertiser runs his campaign and the system provides him with feedback, which of course can be combined with the advertiser's own feedback.

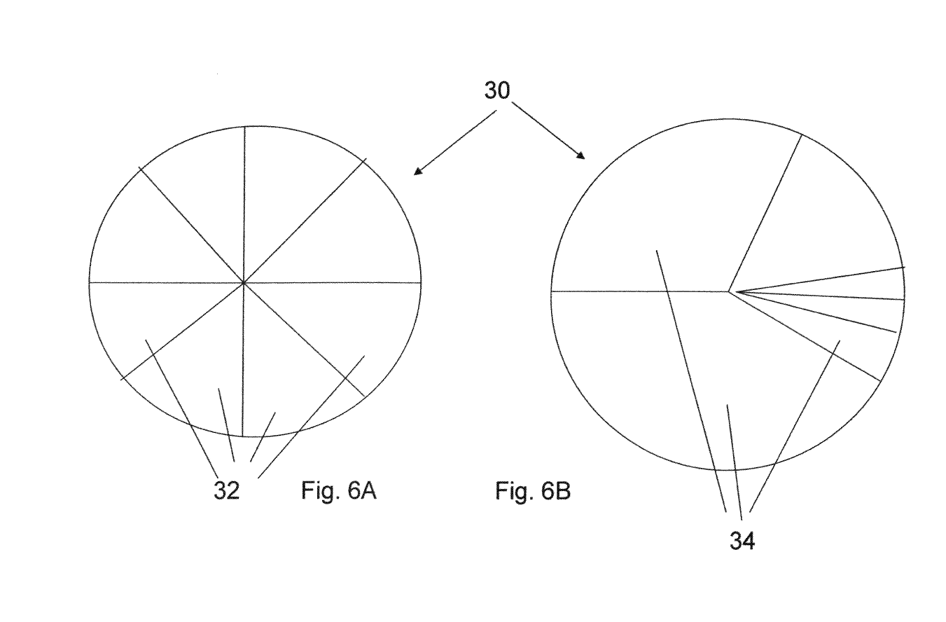

Reference is now made to FIG. 6A, which is a simplified drawing illustrating a stack 30 for assigning keywords between different advertisers, in the highly probable event that two or more advertisers choose the same keywords.

It will be appreciated that in a system with large numbers of advertisers with common themes there will be a need to adjudicate between different advertisers to add a link to a currently downloaded image. Any form of arbitration may be used, but one preferred method is that illustrated in the present figure.

The arbitration method illustrated in FIG. 6A involves assigning each advertiser having a given keyword with a segment 32 within the stack 30. Each time the keyword comes up the advertiser currently at the top of the stack receives the link, and then the stack moves on by one place.

Reference is now made to FIG. 6B, which shows an alternative version of the stack 30, which allows advertisers to have multiple representation or percentage representation in the stack. Thus segments 34 are unequal in size depending on a fee paid by the advertiser, and advertisers may pay for the percentage of the stack that they take for a given keyword.

In a further embodiment of the present invention an ‘in-context’ algorithm is provided so that images can be provided automatically to website texts or other media such as Emails or Text messages (SMS). Thus an article on a website may include a text that mentions books. The text can be read as is without interruption, however if the cursor should approach the word an image of a book may appear, which image can include a link and/or advertising message as in image 10 above. In a further embodiment a complex image having multiple objects may be provided, the complex image being connected with the context of the current text. The one or more individual objects in the image or slogans contain the links to advertisers, as explained above.

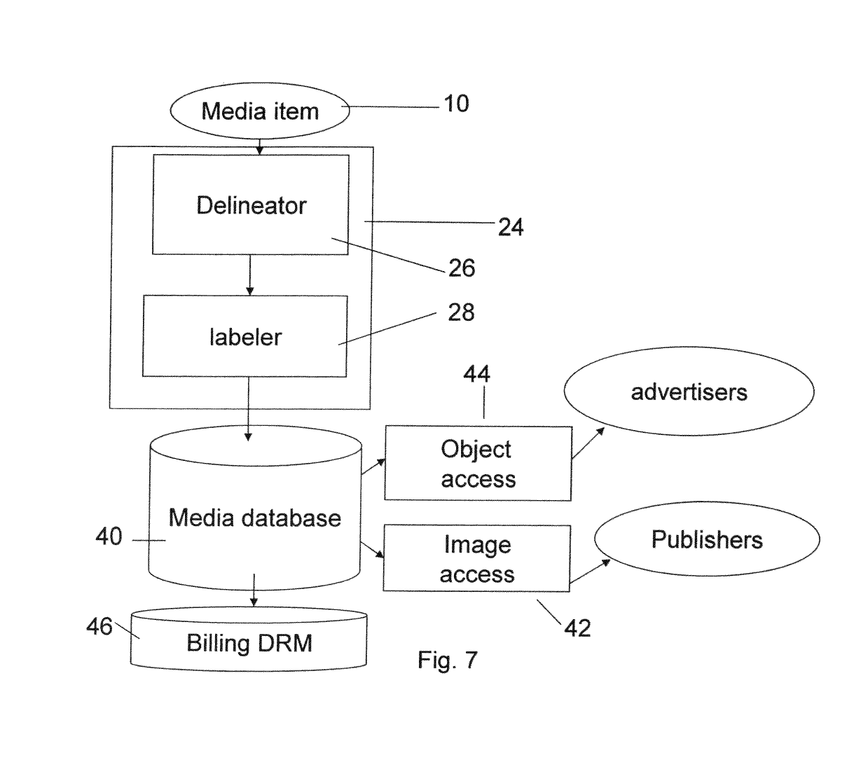

Reference is now made to FIG. 7 which illustrates apparatus for rendering rights protected media freely available to publishing parties over a network such as the Internet. The apparatus comprises the editing tool 24 discussed above, including the object delineator 26 for delineating objects as explained and the tagging tool 28 for labeling the media with keywords and creative slogans. A media item is entered into the editing tool and objects are delineated and keywords and slogans are provided.

A database 40 stores the delineated and labeled media. The media is stored such that different users can search the material in different ways. One point to note is that publishers are interested in the media items as a whole, which they insert into their publications. Advertisers are interested in the individual images that carry objects or slogans. Thus the database requires two search engines, one for images as a whole, a publishers' search engine 42, and one for objects or slogan within the image, an advertisers' search engine 44.

In addition, billing and digital rights management (DRM) unit 46 collects fees from the advertising parties and ensures that all rights users are paid for the use of their images. The DRM unit preferably operates with another sub-system referred to as a clearance system. The clearance system preferably contains a reference database of copyrighted images or other media items and trademarks and whenever a new image/video/music or slogan is uploaded to the database it is compared to the clearance system in order to detect non-original work and thus prevent misuse of copyrighted material.

Collection of fees from advertisers may be based on actual hot links provided, or on number of clicks, or impressions, or goods actually purchased, or on a number of keywords provided, or a percentage of the same keyword using the adjudication methods described above, or on methods currently used in existing Internet systems such as AdSense.

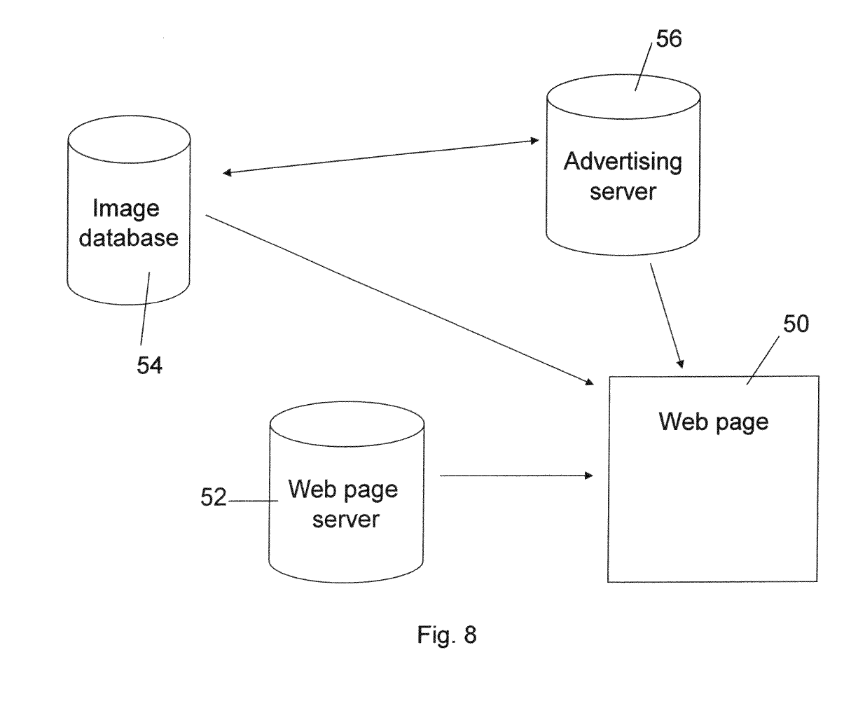

Reference is now made to FIG. 8, which is a simplified diagram illustrating an arrangement for allowing various interested parties to work together over the Internet in order to carry out the present embodiments.

Web page 50, is produced by a web site publishing entity based on a web server 52. The web page publishing entity desires images or other media for its publishing and goes to media database 54 where media is obtained and inserted, preferably free of charge or under any other type of license, and typically by simply inserting, into the website HTML, a link to the database The media includes advertising material and possibly a hot link to the website of the advertiser based on advertising server 56.

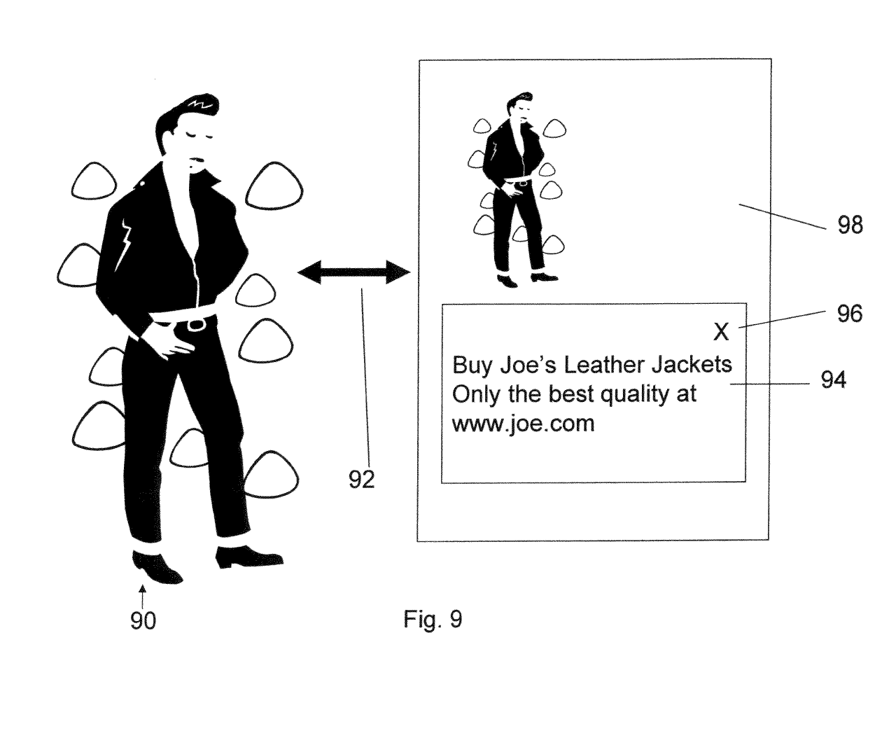

Reference is now made to FIG. 9, which is a simplified diagram illustrating a further embodiment of the present invention. A web designer obtains image 90 for use in his web page. The image has already been categorized as described above, but this time no specific objects have been delimited in the image itself. In this case one of the categories was for jacket and a more specific category of a leather jacket. As a result the image has been hotlinked via self-returning hot link 92 to an advertisement 94 for leather jackets. As the user clicks on the image or moves over the image the hot link 92 is operated. The image 90 appears to diminish and advertisement 94 appears in the vacated space. In this case the advertisement is related to the content of the image but is not hotlinked to any object in the image.

The self-returning hotlink may be activated by clicking on advertisement closing button 96, by clicking generally on the advert-image joint display 98 or by the passage of time without interaction or in any other suitable way.

In sum there is provided a system for making images available free at the point of use over the Internet. The images are paid for by advertising and the advertising fees are divided between the rights holder or image contributor, the database owner, the website owner or publisher, the system provider, and the image editor (who may also be a contributor or a publisher).

It is expected that during the life of this patent many relevant devices and systems will be developed and the scope of the terms herein, particularly of the terms hot-link, hyperlink, and markup language context, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Apparatus for associative display of media items in a hypertext mark up language context, at least one of said media items being an image item, the image item comprising a delineated object within said image, the delineated object comprising a hot link to another location in said hypertext mark up language context, the apparatus being configured with:
a display functionality for displaying said media item; and
a partial-item hotlinking function for recognizing and supporting hotlinking from internal features of said image item, thereby to support said hot link from said delineated object.

2. Apparatus according to claim 1, wherein said media item comprises animation capability within said delineated object, the apparatus further comprising animation functionality configured to animate said delineated object upon activation by a user interface.

3. Apparatus according to claim 1, wherein said delineated object comprises a visual indicator.

4. Apparatus according to claim 1, wherein said media item and said delineated object are respectively associated with keywords.

5. Apparatus according to claim 1, wherein said delineated object is associated with an advertising slogan, said apparatus being configured to display said slogan when said object is activated by the presence of a cursor.

6. Apparatus according to claim 2, configured to display information connected to said hot link upon said activation.

7. Apparatus according to claim 1, wherein said image item comprises any one of the group consisting of sketches, clipart, photographs, images, cartoons, animations, video, video clips and streaming video.

8. Editing device for editing media items for hot-linking, the device comprising:
an interactive object delimiter for allowing a user to delimit objects within a media item for hot-linking, and
an interactive tagging tool for allowing said user to insert keywords to describe respectively delineated objects.

9. The editing device of claim 8, wherein said interactive object delimiter comprises an outline tool for allowing said user to place a boundary around an object to be delimited.

10. The editing device of claim 9, comprising a keyword association tool for associating said boundary with a preselected keyword.

11. The editing device of claim 8, wherein said interactive object delimiter comprises a marker for placing a visual mark within an object to be delimited.

12. The editing device of claim 8, wherein said interactive tagging tool is configured to allow said user to insert an advertising slogan to go with said respectively delineated objects.

13. The editing device of claim 8, wherein said tagging tool is configured to provide a list of keywords and to allow a respective user to associate a respective keyword with a respective object.

14. The editing device of claim 8, wherein said media item is a video item, the editing tool being configured to take a selected frame of said video item and edit said frame as a still image.

15. A method of rendering rights protected media freely available to publishing parties comprising:
obtaining media items;
labeling said media with keywords;
providing publishing parties with access to said media for use thereof;
allowing advertising parties to hot link advertisement material to items identified by said keywords;
collecting usage payments from said advertising parties for use of said media by said publishing parties.

16. The method of claim 15, further comprising delineating objects within said media and allowing said advertising parties to hot link said advertisement material to said delineated objects.

17. The method of claim 16, wherein said delineating comprises marking.

18. The method of claim 15, wherein said labeling further comprises inserting advertising slogans for display to end users.

19. The method of claim 15, further comprising distributing said usage payments between at least one member of the group consisting of the media rights holder, the publishing party and an editor.

20. The method of claim 15, comprising assigning advertisers with keyword percentages, such that a respective advertiser receives a link for the assigned percentage of requests using said keywords from said publishing parties, and calculating said fees based on said percentages.

21. Apparatus for rendering rights protected media available to publishing parties, without at least any initial payment, the apparatus comprising:
a tagging tool for labeling protected media items with keywords;
a database for storing said labeled media items in a manner accessible to publishing parties, to allow said publishing parties to make use thereof; said database being configured to be accessible by said keywords, allowing advertising parties to hot link advertisement material to protected media items identified by said keywords; and
a billing unit configured to collect usage payments from said advertising parties for use of said media items by said publishing parties.

22. The apparatus of claim 21, further comprising an object delineator for delineating objects within said media items.

23. The apparatus of claim 22, wherein said object delineator is a boundary inserter for allowing a user to insert a boundary around said object within said media items.

24. The apparatus of claim 22, wherein said object delineator is a marker for placing a mark within said object within said media.

25. The apparatus of claim 21, wherein said tagging tool is further for allowing a user to insert a slogan to be displayed with said media item upon activation of a respective delineated object.

26. The apparatus of claim 21, further comprising a reporting unit, said reporting unit comprising functionality belonging to at least member of the group of functionalities comprising:
an ability to show a contributor the places his media items appear;
an ability to show an advertiser a set of media items that currently contains his advertisements;
an ability to show a publisher a series of media items ordered so that potentially more profitable images appear earlier.

27. The apparatus of claim 21, further associated with a clearance unit, said clearance unit being a database of reported copyright media, said apparatus being configured to check newly submitted media items against said database.

28. The apparatus of claim 21, wherein said billing is based on said hot linking of advertisement material.

29. A method of providing a database with linkable and keyworded media items, comprising:
providing said media items,
providing an editing tool, the editing tool comprising an interactive tagging tool for allowing a user to insert keywords or slogans to describe said media items;
making said media items and editing tool available to remote users to allow said remote users to add links and keywords to said media items using said editing tool for a fee.

30. The method of claim 29, wherein said editing tool further comprises a function for adding a second media item to said keyworded media item, said second media item to be activated during display at an end user by placing a cursor on said keyworded media item.

31. The method of claim 29, wherein said editing tool further comprises an interactive object delimiter for allowing a user to delimit regions within an image for hot-linking or mark them with a visual mark, thereby to provide a delineated object.

32. The method of claim 31, wherein said editing tool further comprises a function for adding a second media item to said delineated object, said second media item to be activated during display at an end user by placing a cursor on said delineated object.
